(19) United States
(12) Patent Application Publication
(10) Pub. No.: US 2026/0030506 A1
(43) Pub. Date: Jan. 29, 2026

(54) PROMPT-CLASSIFIER METHOD FOR MULTICLASS TEXT CLASSIFICATION IN IMBALANCED DATA

(71) Applicant: Dell Products L.P., Round Rock, TX (US)

(72) Inventors: Leandro Takeshi Hattori, Campo Grande (BR); Karen Braga Enes, Belo Horizonte (BR); Karen Stéfany Martins, Belo Horizonte (BR); Pablo Nascimento da Silva, Niterói (BR); Isabella Costa Maia, Bertioga (BR); Iam Palatnik de Sousa, Rio de Janeiro (BR)

(21) Appl. No.: 18/784,812

(22) Filed: Jul. 25, 2024

(51) Int. Cl. G06N 3/091

(52) U.S. Cl. CPC G06N 3/091

(57) ABSTRACT

One example method includes organizing, using prompt-classifiers (PC), an imbalanced dataset into ‘n’ different classes, and the organizing comprises performing a frequency analysis that identifies a respective number of samples in each of the ‘n’ different classes, and the organizing further comprises structuring, based on the frequency analysis, the imbalanced dataset using a cascaded one-versus-all approach to identify a target class and two remaining classes. Next, the method includes performing a reverse multi-stage prompt-classifier training process that comprises training the prompt-classifiers using the target classes and the two remaining classes, and the training is performed in reverse of an order in which the prompt-classifiers were used to organize the imbalanced dataset. Finally, the method includes performing an inferencing process using one or more of the prompt-classifiers, and the inferencing process continues until a then-current one of the prompt-classifiers correctly identifies the target class.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to data classification. More particularly, at least some embodiments relate to systems, hardware, software, computer-readable media, and methods, for classification of data of an imbalanced dataset.

### BACKGROUND

In real-world scenarios, imbalanced datasets are quite common and present a significant challenge due to the unequal distribution of data instances across two or more classes. Such an imbalance may result in a drop in performance for most multi-classification models, including those for text classification, such as prompt-based learning (PL) classifiers, that is, LM (Language Model) data classifiers using continuous prompts.

While some literature proposes an ensemble of machine learning techniques, those techniques do not consider the capabilities of the PL aspects and LM. Thus, an approach to provide robustness in the unbalanced class scenario of text classification, while keeping efficient of pre-trained LM and PL, is required.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses an overview of various phases of a prompt-classifier, according to one embodiment.

FIG. 2 discloses aspects of a dataset organization process involving four classes that have an imbalanced number of samples, according to one embodiment.

FIG. 3 discloses an example reverse multi-stage training, and forward multi-stage prompt-based learning classifier inference process, according to one embodiment.

FIG. 4 discloses an example schema of a prompt-classifier structure used in stages of a training process and an inference process, according to one embodiment.

FIG. 5 discloses a reverse training algorithm according to one embodiment.

FIG. 6 discloses a multi-stage prompt-classifier method, according to one embodiment.

FIG. 7 discloses output generated by a multi-stage prompt-classifier method, according to one experiment.

FIG. 8 discloses output generated by a multi-stage prompt-classifier method, according to one experiment.

FIG. 9 discloses a computing entity configured and operable to perform any of the disclosed methods, processes, and operations.

### DETAILED DESCRIPTION OF SOME EXAMPLE EMBODIMENTS

Embodiments disclosed herein generally relate to data classification. More particularly, at least some embodiments relate to systems, hardware, software, computer-readable media, and methods, for classification of data of an imbalanced dataset.

In general, one or more embodiments are directed to methods which provide robustness in an unbalanced class scenario of a text classification process, while maintaining the efficiency of a pre-trained LM and PL that may be used for data classification jobs. One example of such a method may comprise the operations: organizing an imbalanced dataset based on class frequency; performing a reverse multi-stage prompt classifier training process; and, performing a forward multi-stage prompt classifier inference process to classify the data of the imbalanced dataset.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a method for training an LM with unbalanced data may reduce model bias. An embodiment may while leverage prompt modules to achieve a parameter-lightweight training solution for a data classification model. An embodiment may leverage prompt modules to achieve a computationally efficient training solution for a data classification model. Various other advantages of one or more example embodiments will be apparent from this disclosure.

### A. References

Mention is made herein of various references. The references may be referred to by the numbers shown in the following list. All of the references in the following list are incorporated herein by reference.
[1] Vaswani, Ashish, et al. “Attention is all you need.” Advances in neural information processing systems 30 (2017).
[2] Wang, Zifeng, et al. “Learning to prompt for continual learning.” Proceedings of the IEEE/CVF Conference on Computer Vision and Pattern Recognition. 2022.
[3] Ebenuwa, Solomon H., et al. “Variance ranking for multi-classed imbalanced datasets: A case study of One-Versus-All.” Symmetry 11.12 (2019):1504.
[4] Doyle, Scott, et al. “Cascaded multi-class pairwise classifier (CASCAMPA) for normal, cancerous, and cancer confounder classes in prostate histology.” 2011 IEEE (Institute of Electrical and Electronics Engineers) international symposium on biomedical imaging: from nano to macro. IEEE, 2011.
[5] Cuimei, Li, et al. “Human face detection algorithm via Haar cascade classifier combined with three additional classifiers.” 2017 13th IEEE International Conference on Electronic Measurement & Instruments (ICEMI). IEEE, 2017.
[6] Hashemi, Sattar, et al. “Adapted one-versus-all decision trees for data stream classification.” IEEE Transactions on Knowledge and Data Engineering 21.5 (2008):624-637.
[7] Zhang, Xiaolong, and Chao Cheng. “Imbalanced data classification algorithm based on boosting and cascade model.” 2012 IEEE International Conference on Systems, Man, and Cybernetics (SMC). IEEE, 2012.
[8] Adhikari, Ashutosh, et al. “Docbert: Bert for document classification.” arXiv preprint arXiv:1904.08398 (2019).
[9] Murarka, Ankit, Balaji Radhakrishnan, and Sushma Ravichandran. “Detection and Classification of mental illnesses on social media using RoBERTa.” arXiv preprint arXiv: 2011.11226 (2020).
[10] Lester, Brian, Rami Al-Rfou, and Noah Constant. “The power of scale for parameter-efficient prompt tuning.” arXiv preprint arXiv:2104.08691 (2021).
[11] Li, Xiang Lisa, and Percy Liang. “Prefix-tuning: Optimizing continuous prompts for generation.” arXiv preprint arXiv:2101.00190 (2021).
[12] Liu, Pengfei, et al. “Pre-train, prompt, and predict: A systematic survey of prompting methods in natural language processing.” arXiv preprint arXiv:2107.13586 (2021).

### B. Context for an Example Embodiment

The following is a discussion of aspects of a context for an embodiment. This discussion is not intended to limit the scope of the claims or this disclosure, or the applicability of the embodiments, in any way.

### B.1 Large Language Model (LLM)

The field of Natural Language Processing (NLP) has highlighted advancements with the emergence of Transformer networks and the availability of larger datasets. As a result, NLP has shifted towards a two-step approach that may be referred to as including the steps of (1) pre-training and (2) fine-tuning.

In a pre-training phase, a model is trained as a LM to predict the likelihood of textual data and learn the general language representations. This process requires large datasets and substantial computational power, often taking months to complete due to its complexity.

After LM pre-training, the LM is fine-tuned for specific downstream tasks, such as sentiment analysis, text summarization, translation, among others. Each task usually involves adapting the pre-trained model individually, necessitating sizable, annotated datasets for each specific task. This fine-tuning step helps the model specialize in the task and improve its performance.

### B.2 Prompt-Based Learning

Recently, the pre-train and fine-tune paradigm has changed to “pre-train, prompt, and predict” and now state-of-the-art methods are based on prompt-based learning. In this new paradigm, downstream tasks are reformulated to look like the tasks learned during the original LM training. To do that, the text input is modified using prompts. It allows large LMs to generalize tasks that were not trained on, with minimal data and performance comparable to fine-tuning. Unlike the last paradigm, a single pre-trained model can be applied to different tasks, reducing computational costs.

Prompt learning can be thought of as comprising three basic steps. The first step, sometimes referred to as “prompt engineering,” applies a function to modify the original input, which uses a template with two empty slots, an input slot [x] and an answer slot [z]. The input slot [x] is filled with the original input. For instance, considering a sentiment analysis task to be performed by an LM, and given the template “[X] The movie is [Z]” and the input “I love this movie.,” the result will be “I love this movie. The movie is [Z].”

In the second step of a prompt learning process, sometimes referred to as the “answer search,” a user needs to define a set of permissible answers Z, that is, for [Z] in the template. Continuing with the sentiment analysis example, the user may have Z={great, fantastic, bad, . . . }. Next, a search is performed over Z, that is, over the set {great, fantastic, bad, . . . }, looking for the highest-scoring text that maximizes the score of the pre-trained LM.

Finally, in the third step of the prompt learning process, sometimes referred to as “answer mapping,” the highest-scoring answer, text from the set {great, fantastic, bad, . . . } in this example, is transformed into the highest-scoring output. For instance, if the highest scoring answer for the input “I love this movie.” is “great,” the final output would be “positive” instead of “negative.”

### B.2.1 Continuous Prompt-Based Learning

Continuous Prompt-based Learning (PL) is an advanced method that extends the concept of prompt-based learning by introducing a continuous space of prompts. See reference [2]. This approach allows for a more flexible and adaptive fine-tuning process, which can lead to improved performance on the task. Unlike human prompts design, which uses a fixed set of prompt tokens, PL introduces a continuous space of prompts. Each prompt in this space is represented as a point in a high-dimensional space, and the model learns to map inputs to the appropriate point in this space. This enables the model to adapt its prompt to the specifics of each input.

The process of performing the PL involves optimizing a loss function that measures the difference between the model's output and the desired output for each input. The model uses gradient-based optimization methods to adjust the prompts and minimize this loss. This process is like the fine-tuning process in traditional LMs, but instead of adjusting the model parameters, the process adjusts the prompts.

### B.3 Multi-Stage Classifier

The multi-stage classifier is a computational intelligence system that addresses the challenges of unbalanced datasets. A multi-stage classifier transforms a multi-class data classification problem into a series of binary classification problems by training multiple binary classifiers, each focused on distinguishing one class from the rest.

The multi-stage classifier ensures equal consideration for each class during training, regardless of class representation. The multi-stage classifier operates sequentially, with each stage building upon the previous one, refining predictions and improving accuracy. This approach effectively handles complex and overlapping classes by capturing subtle differences between them.

By breaking down the multi-class problem and utilizing stages, this classifier type provides an accurate and efficient solution for classification in real-world scenarios. It is a powerful strategy for handling unbalanced datasets, enabling accurate predictions and efficient processing.

### C. Overview of Some General Aspects of an Embodiment

### C.1 Introduction

One example embodiment comprises a method for a prompt-based learning classifier (PC) as an approach for multi-class text classification in imbalanced datasets. One embodiment may operate to divide the original multi-class problem into some binary classification problems and building the binary classification problems in a one-versus-all multi-stage or cascade strategy. By doing this, an embodiment may not only improve the model performance, but may also preserve the original class distribution in the dataset, as such embodiment may not apply any data augmentation processes to the data.

It is noted that the following terms may be used throughout this disclosure:
PC—Prompt Classifier
LM—Language Model
PL—Prompt-based learning
NLP—Natural Language Processing

An embodiment may be effective in dealing with various circumstances and problems. For example, an embodiment may overcome the challenge of class imbalance in multi-class classification tasks that can lead to performance degradation in traditional PL approaches. An embodiment may overcome the problem of loss of semantic information and interference in the data that can occur during the general data augmentation processes for text classification. As a final example, an embodiment may ensure a lightweight process with the addition of prompts for each classifier in the multistage in a low-cost storage space fashion, by reusing the same pre-trained LM (Language Models) for different prompts.

One potential application for an embodiment is Intent Recognition, which shows the intent behind, for example, user queries or customer support tickets, such as information-seeking, troubleshooting, sales inquiries, or complaints. This approach according to an embodiment may enhance customer support processes and enable personalized user experiences.

### C.2 Overview

One embodiment comprises a method to effectively address the challenge of the imbalance classification problem in multi-class text classification tasks. In an embodiment, this approach is based on a sequence of specialist and trainable PL text classifiers, with a pre-trained LM. One particular embodiment comprises three phases, each of which are discussed in turn below.

### C.2.1 Phase 1: Organize the Multi-Stage Dataset Based on Class Frequency:

Phase 1 may comprise the following operations:
1. decompose the dataset into sets rearranged to perform a one-versus-all binary classification-the most frequent class is the “target” class while the “other” class represents the aggregation of all other samples;
2. remove the current most frequent sample;
3. reorganize the next set with a new target class; and
4. repeat steps 2 and 3 until the number of remaining classes is 0.

### C.2.2 Phase 2: Perform the Reverse Multi-Stage Prompt-Classifier Training

Phase 2 may comprise the following operations:
1. The multi-stage training of Phase 2 may be performed in the reverse way-that is, an embodiment may start by training the last classifiers, with the two classes that contain the smallest number of samples;
2. at each stage, reuse the pre-trained LM and the prompt from the prior trained classifier-the weights of the prior pre-trained prompt are frozen, and it is added to its new trainable weights in the PL; and
3. this training process repeats iteratively until the first classifier of the stage has been trained.

### C.2.3 Phase 3: Perform Forward Multi-Stage Prompt-Classifier Inference:

In one embodiment, the inference step operates in the forward direction. That is, starting from the first classifier and progressing toward the last classifier if needed. The idea is that if the current classifier identified the target class, the process finishes. On the other hand, if the model is labeled as “other,” the input text is passed to the next stage classifier.

### C.3 Conclusion

An embodiment comprises a method for training LM with unbalanced data that reduces the model bias while leveraging prompt modules for achieving both a parameter-lightweight and computationally efficient solution. An embodiment may comprise the aspects listed immediately below.

### C.3.1 Training Specialized Prompts for Unbalanced Multi Classification

Traditional PL approaches are not designed to handle unbalanced datasets for multiclass classifiers, often leading to the over-classification of majority classes. In this sense, an embodiment breaks down the problem into some sequential binary classification tasks in a one-against-all multi-stage fashion. Further, employing a systematic approach to decompose intricate problem domains into simplified subproblems enables the handling of imbalanced data distribution without disrupting the data distribution.

### C.3.2 Reuse Prompt Learning Knowledge Training in a Reverse Way

Usually, training a multi-stage classifier traditionally does not leverage knowledge from one model to another one. The approach according to one embodiment enables each prompt to benefit from the knowledge and representations learned by the prior prompts by training the multi-stage classifiers in a reverse way. In this sense, an embodiment takes advantage of the sequential nature of training classifiers in sequential and leverages prior knowledge to improve the current prompt.

### C.3.3 Reuse LM Resource and Adding Only a Lightweight Approach for Fine-Tuning

Usually, a multi-stage classification approach trains an entire model for each stage of the cascade, which can demand a large amount of data and computational time. By way of contrast, a method according to one embodiment exploits the capabilities of a shared pre-trained LM to extract semantic information in all stages. This shared LM facilitates knowledge transfer among classifiers, optimizing resource utilization. Training becomes faster as only a minimal set of prompt weights are updated. Moreover, since an embodiment may not alter the weights of the pre-trained LM, that pre-trained LM may be reused in other downstream services. This efficient feature is not typically explored in conventional multi-stage/cascade classifiers.

### D. Detailed Discussion of Aspects of an Example Embodiment

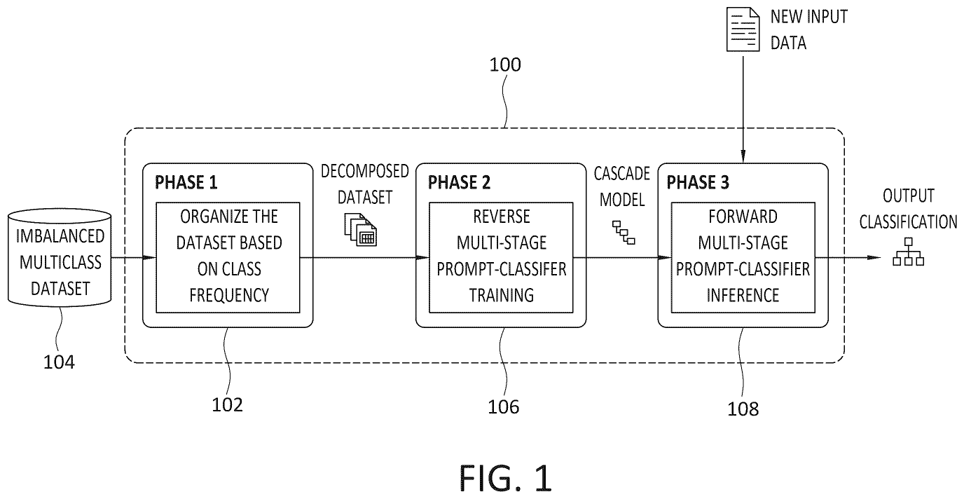

An embodiment comprises a multi-stage prompt-based learning classifier method (PC) in an imbalanced dataset scenario, using a pre-trained LM. With attention now to in FIG. 1, there is disclosed an overview of the main phases of a prompt-classifier (PC) 100 according to one embodiment. By way of introduction to the PC 100, an example is presented that concerns an example application scenario for one embodiment, namely, the Dell Technologies TicketIQ Assist.

### D.1 Example Application Scenario for One Embodiment

Dell Technologies manages a substantial volume of customer support tickets concerning various products and services, and this often results in varying numbers of open tickets across distinct categories. Consider the case of having demands for different ticket categories that may be relevantly discrepant. One feasible way to tackle the challenge of automatically identifying these categories is training a model by employing our proposed approach to separate tickets from the different areas such as, for example, the classes of (1) Hardware Support, (2) Data Center Support, and (3) Software Support.

Instead of asking the model to classify the ticket into all three classes, a method according to one embodiment is implemented in multiple stages. In the first stage, the model, that is, a data classification model, verifies if the ticket belongs to the Hardware Support area, or to another area. If the model predicts that the ticket belongs to the Hardware Support area, the ticket is delivered to this area. Otherwise, the next stage is to identify if the ticket belongs to Data Center Support, or to Software Support.

To train a PC according to one embodiment, first, ticket data was collected from three different areas, which have a different number of samples, thus: Hardware Support>Data Center Support>Software Support. The initial task is to train a model within the PC to recognize the ticket categories with the fewest examples in our dataset, which, in this illustrative example, are (1) Data Center Support, and (2) Software Support. After training this model, an embodiment may use this fine-tuned model as a starting point for the predecessor model, adding new trainable parts to it. Then, the predecessor model is trained to identify the third category with the fewest examples, which in this example is Hardware Support, and a new category representing a mix of Data Center Support and Software Support called “Others.”

By freezing the fine-tuned model, the predecessor model can benefit from the knowledge transferred from the last model, making it easier to train and focus on understanding the new target category. This process continues until all classes have been classified.

Thus, a method according to one embodiment enables the PC to efficiently identify, in this illustrative example, the nuances of incoming tickets and route those tickets to the appropriate support teams without necessitating the use of more technical strategies, such as data augmentation and under-sampling, streamlining customer support operations.

### D.2 Phase 1: Organize the Multi-Stage Dataset Based on Class Frequency

As shown in the example of FIG. 1, a first phase 102 (also referred to as ‘Phase 1’) of the PC 100 may involve the organization of an input unbalanced dataset, or simply ‘dataset,’ 104 based on class frequency within the dataset 104.

In phase 1, an objective is to organize the dataset 104 to perform the multi-stage PC training. The dataset 104 rearranging process comprises n-1 steps, where ‘n’ is the number of classes of data within the dataset 104. The first step is the same for all cases and comprises the frequency analysis step of the classes and the sorting process according to each frequency. The next n−1 steps comprise the dataset restructuring process in a one-versus-all fashion, where the most frequent class is designated as the target class, and all other classes are grouped as the “other” label. This ‘most frequent class’ refers to the class within which the most data samples of the dataset 104 fall.

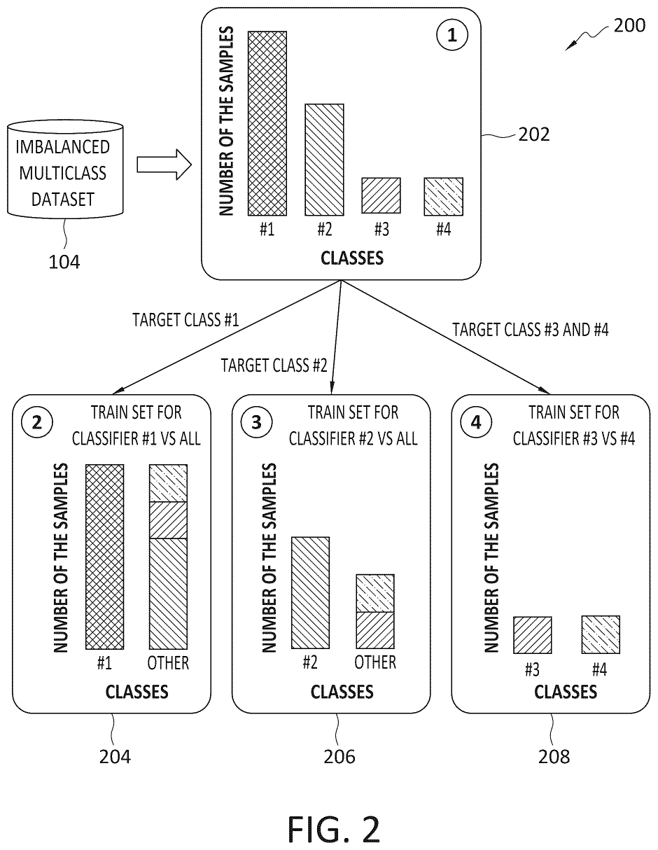

With continued attention to FIG. 1, and directing attention now to FIG. 2, there is disclosed an example of an organization process 200 for a dataset 104 with four classes. In this example, the organization process 200 is divided into four processes 202, 204, 206, and 208, namely, process 202 for the class frequency analysis and processes 204, 206, and 208, for data organization since this example involves 4 classes of the dataset 104. This organization process 200 comprises an element of Phase 1, denoted at 102 in FIG. 1.

In more detail, the organization process 200 comprises a frequency analysis process 202 (part (1) in FIG. 2) in which the frequency analysis process 202 counts the number of data samples, or simply ‘samples,’ per class of a dataset, such as the dataset 104. In this example, there are four classes with a different, or imbalanced, number of samples, where, as shown at 202, class #1 has the majority number of samples, followed by class #2, and class #3 and #4 with smaller respective numbers of samples.

In the next process 204, the dataset is structured using a one-versus-all approach, where the most frequent class is designated as the target class, and all other classes are grouped as the “other” label. After that, an embodiment may remove the target class samples from the dataset, such as the dataset 104, and get the new most frequent class, and finally group all other classes in the “other” class. This process continues iteratively, until only the last two classes in the dataset remain.

In the example depicted in FIG. 2, class #1 is the most frequent, that is, date in class #1 occurs most frequently in the dataset. Then, an embodiment obtains samples of this class and labels as ‘other’ the samples of classes #2, #3, and #4, as shown at 206. Next, an embodiment removes the class #1 samples from the dataset, obtains class #2 as the new target, and merges the remaining classes #3 and #4 into the label ‘other.’ In the last stage 208, class #2 is removed, leaving the samples of classes #3 and #4 remaining

Each portion, or setup, of the dataset, having been obtained by the method 200 discussed above, may be stored in a separate respective dataset denoted as Dᵢ, where i represents the stage where these dataset setups will be used. Thus, in the example of FIG. 2, the dataset generated at 204 is stored in Dᵢ₌₁, the dataset generated at 206 is stored in Dᵢ₌₂, and the final dataset generated at 208 is stored in Dᵢ₌₃. In a scenario with more than four classes, the process 206 may be iterated. On the other hand, in a scenario with three classes, an embodiment may execute only the processes 204 and 208.

It is noted that it is possible that the number of ‘other’ class samples has fewer samples than the target class. In such a case, it may be viable to apply a soft data augmentation. The inverse scenario can occur too, in this case, it can be utilized by under-sampling in the majority class. In any event however, the focus of one embodiment is to make the imbalance of classes less critical, favorizing the model to capture the nuance of the target class compared to others.

### D.3 Phase 2: Reverse Multi-Stage Prompt-Based Learning Classifier Training

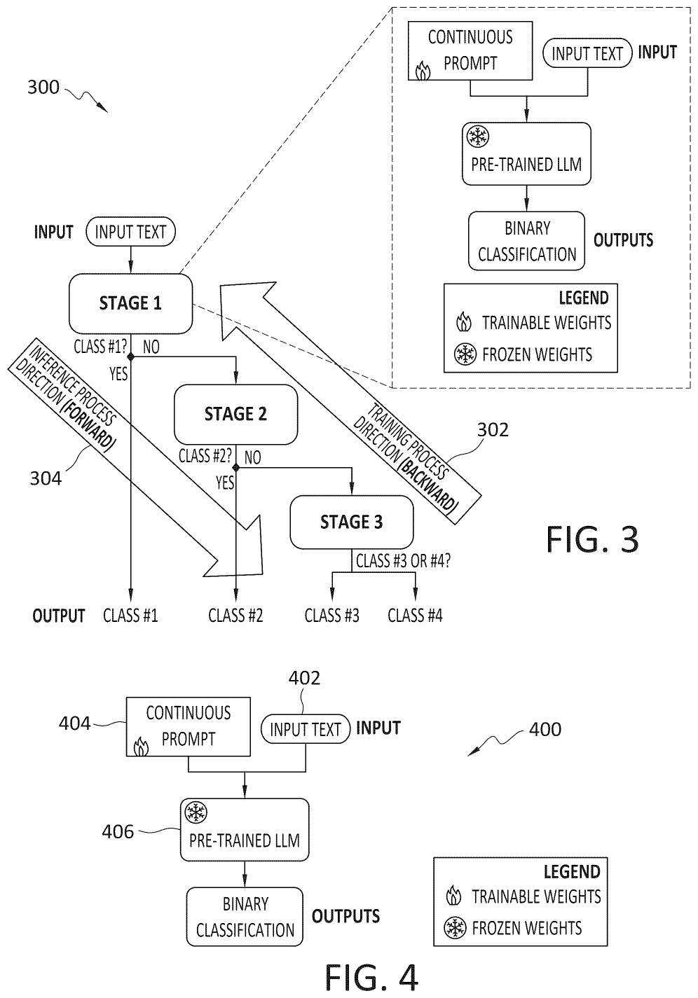

In phase 2, denoted at 106 in FIG. 1, one objective of an embodiment is to train the PC 100 for each stage of a method using the dataset organized in the first phase 102 (phase 1) in a separate way, where the last stage in the cascade is trained first, as illustrated in the example reverse multi-stage prompt-based learning classifier training process 300 of FIG. 3.

Particularly, FIG. 3 discloses that the example process 300 comprises reverse multi-stage training 302 (bottom-right to top-left), and forward multi-stage prompt-based learning classifier inference 304 (top-left to bottom-right). The multi-stage prompt-based learning classifier (PC) training 300 comprises a set of stages S={Sᵢ, i∈{1, 2, . . . n−1}}. Particularly, FIG. 4 discloses an example schema 400 of the PL structure used in each stage of the example process 300.

Each stage Sᵢ (see stages 1, 2, and 3 in FIG. 3) comprises a binary classification model. The binary classification model receives input data 402, a continuous prompt 404, and a pre-trained LLM 406, in which the weights are frozen during the training process. As an example of pre-trained LLM, it could be a RoBERTa or BERT (Bidirectional Encoder Representations from Transformers). Additionally, part of the binary classification model weights is trainable using a prompt-based learning technique, such as Prompt Tuning or Prefix Tuning.

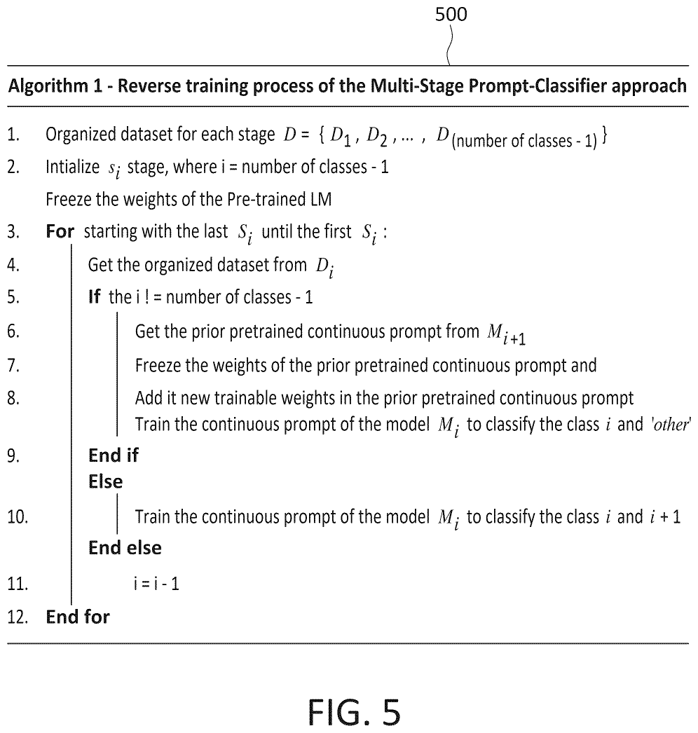

Algorithm 1, indicated at 500 in FIG. 5, outlines the training process of the multi-stage PC approach. The dataset for stage i is represented by Dᵢ, where the process was specified earlier herein. The example algorithm 500 starts by initializing the stage S₍ₙ₋₁₎, where n is the number of classes, and then iterates through each stage in reverse order. For each stage i, the algorithm 500 retrieves the organized dataset, Di, which includes the data pre-processed in Phase 1 (see reference 102 in FIG. 1, and reference 200 in FIG. 2). If the current stage i is the last (in a reverse way, that is, i=n−2) stage, the algorithm 500 trains the PL model to classify class i and class i+1 directly.

If the current stage i is not equal to n−1, the algorithm 500 proceeds to obtain the pre-trained prompt from the prior model. The weights of the prior pre-trained prompt are frozen, and the algorithm 500 incorporates new trainable weights in the prompt for model Mi, where the number of weights added in each step is a parameter of one embodiment that may need to be optimized.

The continuous prompt of model Mi is then trained to classify class i and the ‘other’ class. The algorithm 500 continues to iterate through each stage, decrementing the stage index (i) by 1 until it reaches the first stage, i=1.

Thus, the example algorithm 500 performs a reverse training process for a multi-stage classifier using prompts. The process involves training the continuous prompt of each model, leveraging the knowledge from the prior pre-trained prompt when applicable, and classifying different classes in each stage of the cascade.

### D.4 Phase 3: Forward Multi-Stage Prompt-Based Learning Classifier Inference

In Phase 3, referenced at 108 in FIG. 1, an objective of one embodiment is to perform the multi-stage inference step. In contrast to the training step 302 (see FIG. 3), an embodiment may start the inference 304 (see FIG. 3) in a forward way, that is from the first classifier to the last one.

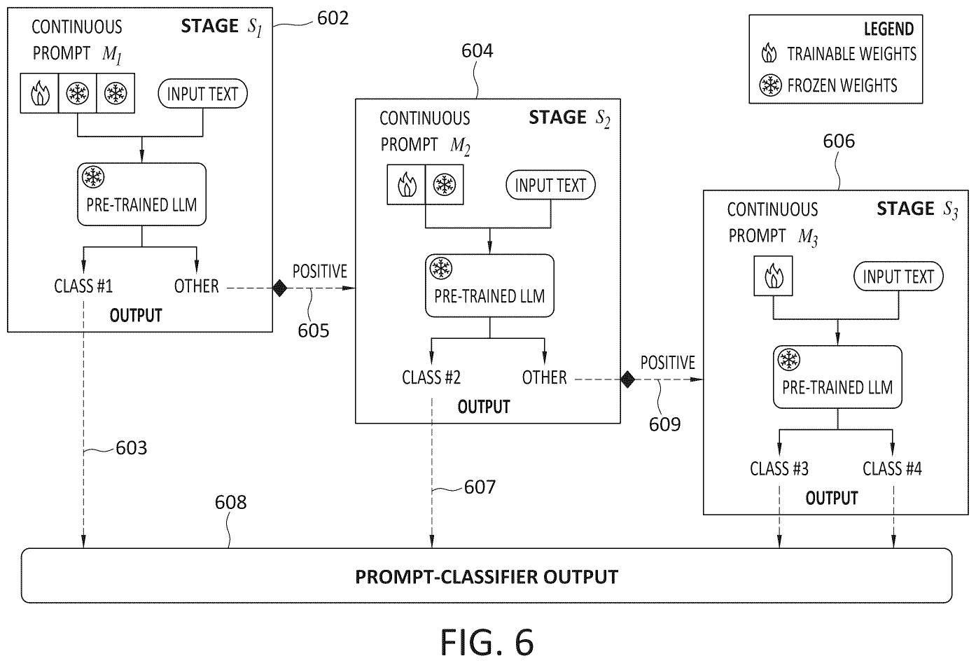

FIG. 6 discloses an inference process 600 implemented in three stages 602, 640, and 606 (see S1, S2, and S3 in FIG. 6), that has four classes, where class #1 is the majority in the training dataset, such as the dataset 104 for example, class #2 is the second most frequent, and classes #3 and #4 are the least frequent as among the classes.

In an embodiment, the inference process 600 begins with the input data classification by model in the stage S₁ referenced at 602. If the M₁ model of stage S₁ predicts the label class #1, the process 600 finishes, and the result is delivered 603 to the user by the prompt-classifier output 608. Otherwise, if the M₁ model of stage S₁ classifies the sample into the class ‘other,’ the input text is sent 605 to the stage S₂ referenced at 604. The logic of the verification is the same as the previous step, but right now is verified if the input text is classified between class #2 or ‘other’ by the model M₂ of stage S₂. In case the input text is classified as class #2, the input sample is sent 607 to the user by the prompt-classifier output 608. On the other hand, if the input text is classified as ‘other’, the input sample is sent 609 to the stage S₃ referenced at 606, where it is classified into class #3 or class #4 by the M₃ model of stage S₃.

### E. Example Experiments and Results

This section discusses a functional experimental example of an embodiment of a multistage solution for PC. To accomplish this task, the inventors used a zero-shot classifier, called bart-large-mnli. Please note that the experiments and results presented herein are based on a specific implementation zero-shot method, and may thus need to be adapted for other uses in some aspects, which are described below. Following immediately below are various Notes applicable to the experiment and results discussed in this section.

Note 1—the method discussed in this Example experiments and results section was subjected to testing using a text input focus. This test utilized the multi-stage strategy employing the one-versus-all approach, as described in our proposed approach. Notably, the model deployed for this evaluation is of the zero-shot classifier, leading to handling of the class “others” via the “not”+<target class>” mechanism. To clarify with an example, in case the observed class is “cat,” the corresponding representation for the “others” class would be “not cat.”

Note 2—The number of samples in the dataset used for the Example experiments and results is beyond the control of the inventors, as it involves a pre-trained model without any additional training. To simulate this real-world limitation, the inventors opted to utilize a set comprising feline species. However, it is pertinent to note that the semantic information in the training dataset may exhibit imbalances. For instance, certain feline themes may be more prevalent than information related to cougars in any web-crawled text dataset.

Note 3—In this Example experiments and results section, the inventors compare the results of the multiclass classification with the multi-stage classification using the same zero-shot classifier.

Note 4—The test in this Example experiments and results does not invalidate any of the disclosed embodiments. To address a more specialized scenario, it still becomes necessary to employ a fine-tuning method. For example, consider the example discussed earlier herein, where a particular set of internal Dell Technologies terminology and concepts are not contained in the dataset utilized for training the bart-large-mnli language model. In such a case, an embodiment can bridge this deficiency by fine-tuning a pre-trained LM to enhance its performance in this specific task.

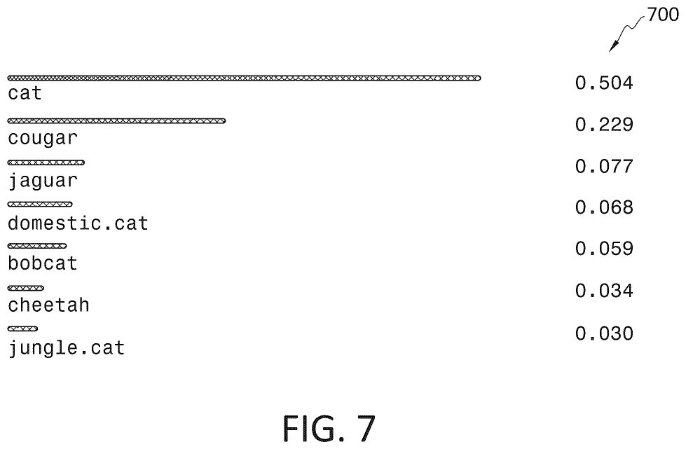

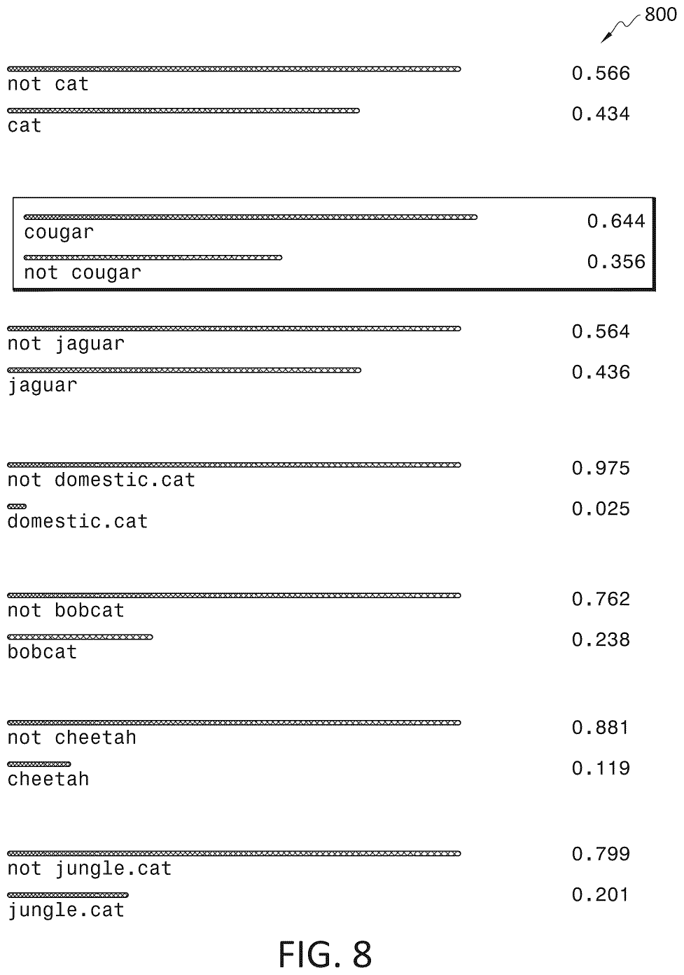

Turning now to the parameters of the experiment conducted in connection with this section, consider the following:
Model: https://huggingface.co/facebook/bart-large-mnli
Prompt: “There is a presence in North and South America, from dense forests to mountains and deserts. This animal is identified by its large size, they are heavy, and huge. They are skilled hunters and have a solitary hunting style, relying on stealth and ambush techniques. They are not domestic cats. Their vocal repertoire is different from other large felines, giving them a unique form of communication. They are primarily found in northern regions, such as North America, Europe, and Asia. It prefers habitats with dense underbrush and rocky areas for stalking, but it can live in open areas. Individual territory sizes depend on terrain, vegetation, and abundance of prey. Attacks on humans remain rare, despite a recent increase in frequency. It has killed to American black bears, grizzly bears, and wolf packs. It is an ambush predator that pursues a wide variety of prey. It is largely solitary by nature and considered both nocturnal and crepuscular, although daytime sightings do occur.”
Label: cougar
Multiclass classification: cougar,cat,domestic.cat,jungle.cat,jaguar,cheetah,bobcat
Output: FIG. 7 discloses example output 700.
Cascade one-versus-all: <target class>, <not target class>
Outputs: FIG. 8 discloses example output 800

In this functional experiment, the inventors observed that it could be hard to identify the target (feline cougar) given the model different class possibilities. Also, some classes could be more frequent in the dataset than others, and this is normal behavior in the real world.

On the other hand, when the problem is divided into sub-binary classifications in a multi-stage, as in one example embodiment, it may be observed that the model can identify the target class (cougar). Notably, it was possible to identify the correct class against all other classes. This result could give rise to an intuition that the model can be more adept at obtaining the details analyzing the class one by one. Also, it is worth noting that this result is delivered without any type of training (zero-shot), which could indicate a potential strategy if there is a training step.

### F. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments. These are presented only by way of example and are not intended to limit the scope of this disclosure or the claims in any way.

Embodiment 1. A method, comprising: organizing, using prompt-classifiers (PC), an imbalanced dataset into ‘n’ different classes, and the organizing comprises performing a frequency analysis that identifies a respective number of samples in each of the ‘n’ different classes, and the organizing further comprises structuring, based on the frequency analysis, the imbalanced dataset using a cascaded one-versus-all approach to identify a target class and two remaining classes; performing a reverse multi-stage prompt-classifier training process that comprises training the prompt-classifiers using the target classes and the two remaining classes, and the training is performed in reverse of an order in which the prompt-classifiers were used to organize the imbalanced dataset; and performing an inferencing process using one or more of the prompt-classifiers, and the inferencing process continues until a then-current one of the prompt-classifiers correctly identifies the target class.

Embodiment 2. The method as recited in any preceding embodiment, wherein the target class is a class that contains the most samples.

Embodiment 3. The method as recited in any preceding embodiment, wherein the two remaining classes contain the fewest number of samples of all the classes that were identified in the organizing process, and the reverse multi-stage prompt-classifier training process is performed beginning with the two remaining classes.

Embodiment 4. The method as recited in any preceding embodiment, wherein each stage of the reverse multi-stage prompt-classifier training process is performed by a respective one of the prompt-classifiers, and each of the prompt-classifiers comprises a respective pre-trained language model (LM) that generates a classification output based on inputs that comprise a continuous prompt and input text from another one of the prompt-classifiers.

Embodiment 5. The method as recited in any preceding embodiment, wherein the reverse multi-stage prompt-classifier training process continues until a first one of the prompt-classifiers of each stage has been trained.

Embodiment 6. The method as recited in any preceding embodiment, wherein the inferencing process continues when another then-current one of the prompt-classifiers identifies a class of data as being one of the other classes.

Embodiment 7. The method as recited in any preceding embodiment, wherein the inferencing process is performed beginning with the prompt-classifier that was employed at a last stage of the reverse multi-stage prompt-classifier training process.

Embodiment 8. The method as recited in any preceding embodiment, wherein at each stage of the reverse multi-stage prompt-classifier training process, one of the prompt-classifiers uses a pre-trained language model and continuous prompt from a preceding one of the prompt-classifiers, and weights associated with that continuous prompt are frozen.

Embodiment 9. The method as recited in any preceding embodiment, wherein the cascaded one-versus-all approach comprises identifying, as the target class, a class that includes the most samples in the imbalanced dataset, and identifying, as the two remaining classes, an aggregation of all remaining samples of the imbalanced dataset.

Embodiment 10. The method as recited in any preceding embodiment, wherein the two remaining samples contain, respectively, a smallest number of samples, and a second smallest number of samples, and the reverse multi-stage prompt-classifier training process begins with the two remaining samples.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

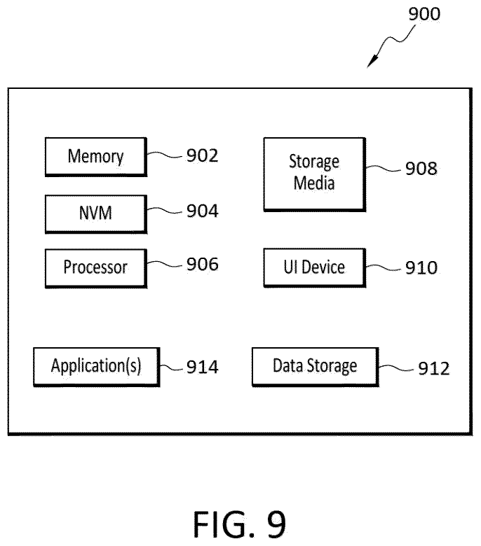

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
organizing, using prompt-classifiers (PC), an imbalanced dataset into ‘n’ different classes, and the organizing comprises performing a frequency analysis that identifies a respective number of samples in each of the ‘n’ different classes, and the organizing further comprises structuring, based on the frequency analysis, the imbalanced dataset using a cascaded one-versus-all approach to identify a target class and two remaining classes;
performing a reverse multi-stage prompt-classifier training process that comprises training the prompt-classifiers using the target classes and the two remaining classes, and the training is performed in reverse of an order in which the prompt-classifiers were used to organize the imbalanced dataset; and
performing an inferencing process using one or more of the prompt-classifiers, and the inferencing process continues until a then-current one of the prompt-classifiers correctly identifies the target class.

2. The method as recited in claim 1, wherein the target class is a class that contains the most samples.

3. The method as recited in claim 1, wherein the two remaining classes contain the fewest number of samples of all the classes that were identified in the organizing process, and the reverse multi-stage prompt-classifier training process is performed beginning with the two remaining classes.

4. The method as recited in claim 1, wherein each stage of the reverse multi-stage prompt-classifier training process is performed by a respective one of the prompt-classifiers, and each of the prompt-classifiers comprises a respective pre-trained language model (LM) that generates a classification output based on inputs that comprise a continuous prompt and input text from another one of the prompt-classifiers.

5. The method as recited in claim 1, wherein the reverse multi-stage prompt-classifier training process continues until a first one of the prompt-classifiers of each stage has been trained.

6. The method as recited in claim 1, wherein the inferencing process continues when another then-current one of the prompt-classifiers identifies a class of data as being one of the other classes.

7. The method as recited in claim 1, wherein the inferencing process is performed beginning with the prompt-classifier that was employed at a last stage of the reverse multi-stage prompt-classifier training process.

8. The method as recited in claim 1, wherein at each stage of the reverse multi-stage prompt-classifier training process, one of the prompt-classifiers uses a pre-trained language model and continuous prompt from a preceding one of the prompt-classifiers, and weights associated with that continuous prompt are frozen.

9. The method as recited in claim 1, wherein the cascaded one-versus-all approach comprises identifying, as the target class, a class that includes the most samples in the imbalanced dataset, and identifying, as the two remaining classes, an aggregation of all remaining samples of the imbalanced dataset.

10. The method as recited in claim 1, wherein the two remaining samples contain, respectively, a smallest number of samples, and a second smallest number of samples, and the reverse multi-stage prompt-classifier training process begins with the two remaining samples.

11. A non-transitory storage medium having stored therein instructions that are executable by one or more hardware processors to perform operations comprising:
organizing, using prompt-classifiers (PC), an imbalanced dataset into ‘n’ different classes, and the organizing comprises performing a frequency analysis that identifies a respective number of samples in each of the ‘n’ different classes, and the organizing further comprises structuring, based on the frequency analysis, the imbalanced dataset using a cascaded one-versus-all approach to identify a target class and two remaining classes;
performing a reverse multi-stage prompt-classifier training process that comprises training the prompt-classifiers using the target classes and the two remaining classes, and the training is performed in reverse of an order in which the prompt-classifiers were used to organize the imbalanced dataset; and
performing an inferencing process using one or more of the prompt-classifiers, and the inferencing process continues until a then-current one of the prompt-classifiers correctly identifies the target class.

12. The non-transitory storage medium as recited in claim 11, wherein the target class is a class that contains the most samples.

13. The non-transitory storage medium as recited in claim 11, wherein the two remaining classes contain the fewest number of samples of all the classes that were identified in the organizing process, and the reverse multi-stage prompt-classifier training process is performed beginning with the two remaining classes.

14. The non-transitory storage medium as recited in claim 11, wherein each stage of the reverse multi-stage prompt-classifier training process is performed by a respective one of the prompt-classifiers, and each of the prompt-classifiers comprises a respective pre-trained language model (LM) that generates a classification output based on inputs that comprise a continuous prompt and input text from another one of the prompt-classifiers.

15. The non-transitory storage medium as recited in claim 11, wherein the reverse multi-stage prompt-classifier training process continues until a first one of the prompt-classifiers of each stage has been trained.

16. The non-transitory storage medium as recited in claim 11, wherein the inferencing process continues when another then-current one of the prompt-classifiers identifies a class of data as being one of the other classes.

17. The non-transitory storage medium as recited in claim 11, wherein the inferencing process is performed beginning with the prompt-classifier that was employed at a last stage of the reverse multi-stage prompt-classifier training process.

18. The non-transitory storage medium as recited in claim 11, wherein at each stage of the reverse multi-stage prompt-classifier training process, one of the prompt-classifiers uses a pre-trained language model and continuous prompt from a preceding one of the prompt-classifiers, and weights associated with that continuous prompt are frozen.

19. The non-transitory storage medium as recited in claim 11, wherein the cascaded one-versus-all approach comprises identifying, as the target class, a class that includes the most samples in the imbalanced dataset, and identifying, as the two remaining classes, an aggregation of all remaining samples of the imbalanced dataset.

20. The non-transitory storage medium as recited in claim 11, wherein the two remaining samples contain, respectively, a smallest number of samples, and a second smallest number of samples, and the reverse multi-stage prompt-classifier training process begins with the two remaining samples.
